(19) United States
(12) Patent Application Publication
(10) Pub. No.: US 2014/0244168 A1
(43) Pub. Date: Aug. 28, 2014

(54) POSITIONING APPARATUS, INTEGRATED CIRCUIT APPARATUS, ELECTRONIC DEVICE AND PROGRAM

(71) Applicant: SEIKO EPSON CORPORATION, Tokyo (JP)

(72) Inventor: Masakazu ISOMURA, Setagaya-ku (JP)

(73) Assignee: SEIKO EPSON CORPORATION, Tokyo (JP)

(21) Appl. No.: 14/184,962

(22) Filed: Feb. 20, 2014

(30) Foreign Application Priority Data
Feb. 27, 2013 (JP) 2013-037361

(51) Int. Cl. G01C 21/00

(52) U.S. Cl. CPC G01C 21/00
USPC 701/518

(57) ABSTRACT

A positioning apparatus 1 includes a first positioning unit 10 that performs first positioning processing that is performed based on a radio signal, an autonomous positioning sensor 20 that detects a state of the positioning apparatus 1, a second positioning unit 30 that performs second positioning processing that is performed based on an output of the autonomous positioning sensor 20, an attitude determining unit 40 that determines whether or not the attitude of the positioning apparatus 1 has been changed based on the output of the autonomous positioning sensor 20, and a control unit 50 that controls the first positioning unit 10. The control unit 50 performs control so as to cause the first positioning unit 10 to perform the first positioning processing if the attitude determining unit 40 determines that the attitude of the positioning apparatus 1 has been changed.

The present application claims a priority based on Japanese Patent Application No. 2013-037361 filed on Feb. 27, 2013, the contents of which are incorporated herein by reference.

### BACKGROUND

1. Technical Field

The invention relates to a positioning apparatus, an integrated circuit apparatus, an electronic device and a program.

2. Related Art

Conventionally, an apparatus has been developed that performs positioning by a combined use of GPS (Global Positioning System) positioning and autonomous positioning that uses an acceleration sensor, a geomagnetic sensor and the like, and stores position data at each location along its moving path. Autonomous positioning is possible even in areas where radio waves from the GPS satellite do not reach by continuously measuring the relative amount of movement and the moving direction. Generally, autonomous positioning can be performed with a smaller power consumption than GPS positioning.

However, in the case of an autonomous positioning apparatus being carried on a person, various carried states can be conceived such as being carried in a pocket, in a bag or in hand, and thus the autonomous positioning apparatus is required to accurately estimate the moving direction in all of the carried states.

JP-A-2012-98263 discloses a technique in which the moving direction is estimated based on geomagnetic orientation detected by a geomagnetic sensor and a pattern of output variations of an acceleration sensor.

Meanwhile, JP-A-2012-98137 discloses a technique in which the carried state of the positioning apparatus is determined, and the autonomous positioning mode is switched according to the determined state so as to prevent the accuracy of positioning of autonomous positioning from deteriorating even when the carried state is changed.

However, when the carried state of the positioning apparatus is changed by the user during autonomous positioning, the moving direction may be incorrectly determined due to the change. As a result, a problem may arise in that, for example, despite the fact that the user is going straight ahead, it is determined that movement information has been changed when the carried state is changed, and the movement trajectory is curved. Even if correction such as rotation or scaling is performed on the movement trajectory such that the position data obtained by GPS matches the position data obtained by autonomous positioning as in the technique of JP-A-2012-98263, a sufficient correction effect cannot be obtained due to the shape of the movement trajectory itself being different from the original shape, resulting in deterioration of the accuracy of positioning.

Also, if the positioning apparatus supports only a few carried states, it is possible to perform determination and switching of the autonomous positioning mode according to the carried state as in JP-A-2012-98137, but if the positioning apparatus supports a large number of carried states, it is not practical to use the method in which an optimal mode is determined according to each state and switching is performed to the optimal mode. Also, if autonomous positioning is performed in an unsupported carried state, the accuracy of positioning may deteriorate.

### SUMMARY

An advantage of some aspects of the invention is to provide a positioning apparatus, an integrated circuit apparatus, an electronic device and a program that are capable of improving the accuracy of positioning.

### Application Example 1

A positioning apparatus according to the present application example is a positioning apparatus including: a first positioning unit that performs first positioning processing that is performed based on a radio signal; an autonomous positioning sensor that detects a state of the positioning apparatus; a second positioning unit that performs second positioning processing that is performed based on an output of the autonomous positioning sensor; an attitude determining unit that determines whether or not an attitude of the positioning apparatus has been changed based on the output of the autonomous positioning sensor; and a control unit that controls the first positioning unit, wherein the control unit performs control so as to cause the first positioning unit to perform the first positioning processing if the attitude determining unit determines that the attitude of the positioning apparatus has been changed.

Changes in the attitude of the positioning apparatus tend to decrease the accuracy of autonomous positioning. According to the present application example, if the attitude of the positioning apparatus is changed, the first positioning processing that is performed based on a radio signal is performed, and thus a positioning apparatus that can improve the accuracy of positioning can be implemented.

### Application Example 2

In the above-described positioning apparatus, it is preferable that the autonomous positioning sensor includes an acceleration sensor, and the attitude determining unit determines whether or not the attitude of the positioning apparatus has been changed based on changes in gravity direction vector detected by the acceleration sensor.

With this configuration, it is possible to easily detect changes in the attitude of the positioning apparatus.

### Application Example 3

In the above-described positioning apparatus, it is preferable that the attitude determining unit determines whether or not the attitude of the positioning apparatus has been changed based on a result of low-pass filter processing of the changes in gravity direction vector.

With this configuration, small changes in the attitude of the positioning apparatus that occur when, for example, the user is walking while viewing the positioning apparatus in hand can be ignored, and it is therefore possible to prevent the first positioning processing that requires a larger power consumption than the second positioning processing from being performed more than necessary. Accordingly, a positioning apparatus having a small power consumption can be implemented.

### Application Example 4

In the above-described positioning apparatus, it is preferable that the autonomous positioning sensor further includes a geomagnetic sensor, and the attitude determining unit further determines whether or not the attitude of the positioning apparatus has been changed based on changes in yaw angle per unit time detected by the acceleration sensor and the geomagnetic sensor.

With this configuration, even when the travel direction of the positioning apparatus is changed suddenly, it can be detected as a change in the attitude of the positioning apparatus.

### Application Example 5

In the above-described positioning apparatus, it is preferable that the positioning apparatus further includes a correction unit that performs correction processing, the first positioning unit performs, during movement from a first location to a second location, the first positioning processing intermittently at the first location and the second location, the second positioning unit performs the second positioning processing so as to acquire a series of position data regarding movement from the first location to the second location, and in order for a movement trajectory corresponding to the series of position data to have a similar shape before and after the correction processing, in the correction processing, the correction unit corrects the series of position data by uniformly rotating and scaling the series of position data such that one end of the movement trajectory matches a location corresponding to the first location obtained as a result of positioning performed by the first positioning unit, and the other end of the movement trajectory matches a location corresponding to the second location obtained as a result of positioning performed by the first positioning unit.

With this configuration, the movement trajectory obtained in the second positioning processing can be corrected so as to be closer to the actual moving path.

### Application Example 6

An integrated circuit apparatus according to the present application example includes: a first input unit that receives input of location-related information that is information regarding positions based on a radio signal; a first positioning unit that performs first positioning processing that is performed based on the location-related information; a second input unit that receives input of detection result information that is information regarding a result of detection performed by an autonomous positioning sensor; a second positioning unit that performs second positioning processing that is performed based on the detection result information; an attitude determining unit that determines whether or not an attitude of the autonomous positioning sensor has been changed based on the detection result information; and a control unit that controls the first positioning unit, and the control unit performs control so as to cause the first positioning unit to perform the first positioning processing if the attitude determining unit determines that the attitude of the autonomous positioning sensor has been changed.

Changes in the attitude of the autonomous positioning sensor tend to decrease the accuracy of autonomous positioning. According to the present application example, if the attitude of the autonomous positioning sensor is changed, the first positioning processing that is performed based on a radio signal is performed, and thus an integrated circuit apparatus that can improve the accuracy of positioning can be implemented.

### Application Example 7

An electronic device according to the present application example includes the above-described positioning apparatus or the above-described integrated circuit apparatus.

With this configuration, an electronic device that can improve the accuracy of positioning can be implemented.

### Application Example 8

A program according to the present application example is a program that causes a computer to function as: a first input unit that receives input of location-related information that is information regarding positions based on a radio signal; a first positioning unit that performs first positioning processing that is performed based on the location-related information; a second input unit that receives input of detection result information that is information regarding a result of detection performed by an autonomous positioning sensor; a second positioning unit that performs second positioning processing that is performed based on the detection result information; an attitude determining unit that determines whether or not an attitude of the autonomous positioning sensor has been changed based on the detection result information; and a control unit that controls the first positioning unit, wherein the control unit performs control so as to cause the first positioning unit to perform the first positioning processing if the attitude determining unit determines that the attitude of the autonomous positioning sensor has been changed.

Changes in the attitude of the autonomous positioning sensor tend to decrease the accuracy of autonomous positioning. According to the present application example, if the attitude of the autonomous positioning sensor is changed, the first positioning processing that is performed based on a radio signal is performed, and thus a program that can improve the accuracy of positioning can be implemented.

### BRIEF DESCRIPTION OF THE DRAWINGS

The invention will be described with reference to the accompanying drawings, wherein like numbers reference like elements.

FIG. 1 is a functional block diagram of a positioning apparatus 1 according to an embodiment of the invention.

FIG. 2 is a block diagram specifically showing an example of a configuration of the positioning apparatus 1 according to the embodiment.

FIGS. 3A, 3B and 3C are diagrams showing examples of the external views of an electronic device 1000.

FIG. 4 is a flowchart illustrating an example of operations of the positioning apparatus 1 of the embodiment.

FIG. 5A is a graph showing an example of a result of detection by a triaxial acceleration sensor 21, and FIG. 5B is a graph showing an example of a result of detection of the axis where the gravity direction vector is dominant.

FIGS. 6A and 6B are diagrams illustrating correction processing.

FIGS. 7A and 7B are diagrams illustrating correction processing according to a conventional technique.

### DESCRIPTION OF EXEMPLARY EMBODIMENTS

Hereinafter, preferred embodiments of the invention will be described in detail with reference to the drawings. The drawings that are referred to are provided only for convenience of description. It is to be understood that the embodiments described below are not intended to unduly limit the scope of the invention recited in the claims. It is also understood that all of the constituent elements described below are not necessarily essential to the invention.

1. Overall Configuration

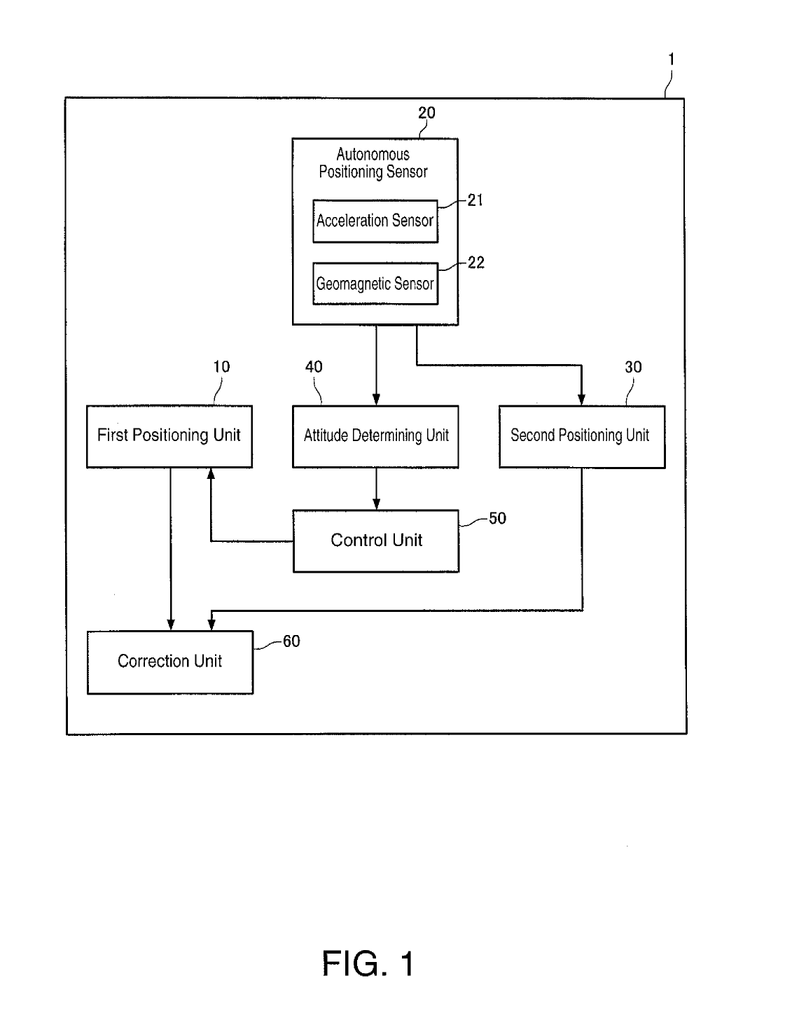

FIG. 1 is a functional block diagram of a positioning apparatus 1 according to an embodiment of the invention. In the embodiment below, an example will be described in which the positioning apparatus 1 is a portable positioning apparatus that can be easily carried by a user.

The positioning apparatus 1 according to the present embodiment includes a first positioning unit 10 that performs first positioning processing that is performed based on a radio signal, an autonomous positioning sensor 20 that detects a state of the positioning apparatus 1, a second positioning unit 30 that performs second positioning processing that is performed based on an output of the autonomous positioning sensor 20, an attitude determining unit 40 that determines whether or not the attitude of the positioning apparatus 1 has been changed based on the output of the autonomous positioning sensor 20, and a control unit 50 that controls the first positioning unit 10. The control unit 50 performs control so as to cause the first positioning unit 10 to perform the first positioning processing if the attitude determining unit 40 determines that the attitude of the positioning apparatus 1 has been changed.

The first positioning unit 10 performs first positioning processing that is performed based on a radio signal. The radio signal can be any type of radio signal that can be used to perform positioning such as a radio signal from a positioning satellite such as the GPS or GLONASS (Global Navigation Satellite System), a radio signal from a mobile phone base station, or a Wi-Fi (Wireless Fidelity) radio signal. In the present embodiment, an example will be described in which a radio signal from the GPS satellite is used as the radio signal. In the first positioning processing, the first positioning unit 10 can acquire position data indicating the current position by performing a predetermined positioning computation based on data included in the radio signal from the GPS satellite.

The autonomous positioning sensor 20 detects movement and orientation. The autonomous positioning sensor 20 is provided in the positioning apparatus 1 such that its attitude changes in conjunction with changes in the attitude of the positioning apparatus 1. The autonomous positioning sensor 20 outputs the detected movement and orientation to the second positioning unit 30 and the attitude determining unit 40. In the present embodiment, the autonomous positioning sensor 20 includes a triaxial acceleration sensor 21 and a triaxial geomagnetic sensor 22. The acceleration sensor 21 detects the magnitude of acceleration in each of the three mutually orthogonal axial directions. The geomagnetic sensor 22 detects the magnitude of a magnetic field in each of the three mutually orthogonal axial directions.

The second positioning unit 30 performs second positioning processing that is performed based on the output of the autonomous positioning sensor 20. In the present embodiment, in the second positioning processing, the second positioning unit 30 receives measured data from the acceleration sensor 21 and the geomagnetic sensor 22 at a predetermined sampling period, and calculates the moving direction and the amount of movement of the positioning apparatus 1 based on the received measured data.

To be more specific, the second positioning unit 30 calculates the moving direction from a pattern of output variations that are specific to walking and that occur in the output of the acceleration sensor 21. When a user walks, the torso of the user significantly tilts back and forth and rolls slightly in the right and left directions. At this time, if the positioning apparatus 1 is attached to the torso of the user, the positioning apparatus 1 is moved according to the movement of the user, and thus the movement of the positioning apparatus 1 is reflected in the output of the acceleration sensor 21. The second positioning unit 30 can calculate a direction of the positioning apparatus 1 in which the user is heading by analyzing the pattern of output variations. Also, the second positioning unit 30 can determine a direction of the positioning apparatus 1 that corresponds to the gravity direction based on the output of the acceleration sensor 21, and can determine a direction of the positioning apparatus 1 that corresponds to the magnetic north direction based on an output of the geomagnetic sensor 22. Accordingly, the moving direction of the user can be determined by the orientation based on these results.

Also, the second positioning unit 30 detects up and down movements of the positioning apparatus 1 based on the output of the acceleration sensor 21, and counts the number of walking steps based on the detected up and down movements. Then, the number of walking steps is multiplied by pre-set walking stride data and thereby the amount of movement by walking is calculated.

The attitude determining unit 40 determines whether or not the attitude of the positioning apparatus 1 has been changed based on the output of the autonomous positioning sensor 20. In the present embodiment, if the attitude of the positioning apparatus 1 is changed by a predetermined amount or more, the attitude determining unit 40 determines that the attitude of the positioning apparatus 1 has been changed. A configuration is also possible in which, for example, if the roll angle or pitch angle is changed by a predetermined value or more, the attitude determining unit 40 determines that the attitude of the positioning apparatus 1 has been changed. The attitude determining unit 40 outputs the determined result to the control unit 50.

The control unit 50 controls the first positioning unit 10. To be more specific, the control unit 50 performs control so as to cause the first positioning unit 10 to perform the first positioning processing if the attitude determining unit 40 determines that the attitude of the positioning apparatus 1 has been changed.

Changes in the attitude of the positioning apparatus 1 tend to decrease the accuracy of the second positioning processing (autonomous positioning). According to the present application example, if the attitude of the positioning apparatus 1 is changed, first positioning processing that is performed based on a radio signal is performed, and thus a positioning apparatus 1 that can improve the accuracy of positioning can be implemented.

The attitude determining unit 40 may determine whether or not the attitude of the positioning apparatus 1 has been changed based on changes in the gravity direction vector detected by the acceleration sensor 21. For example, it may be determined that the attitude of the positioning apparatus 1 has been changed if the sensing axis where the gravity direction vector is dominant changes. With this configuration, changes in the attitude of the positioning apparatus 1 can be easily detected. A specific example of operations will be described later in “2. Example of Operations” section.

The attitude determining unit 40 may determine whether or not the attitude of the positioning apparatus 1 has been changed based on a result of low-pass filter processing of changes in the gravity direction vector. With this configuration, small changes in the attitude of the positioning apparatus 1 that occur when, for example, the user is walking while viewing the positioning apparatus 1 in hand can be ignored, it is therefore possible to prevent the first positioning processing that requires a larger power consumption than the second positioning processing from being performed more than necessary. Accordingly, a positioning apparatus 1 having a small power consumption can be implemented.

Furthermore, the attitude determining unit 40 may determine whether or not the attitude of the positioning apparatus 1 has been changed based on changes in the yaw angle per unit time detected by the acceleration sensor 21 and the geomagnetic sensor 22. With this configuration, even when the travel direction of the positioning apparatus 1 is changed suddenly, it can be detected as a change in the attitude of the positioning apparatus 1.

The positioning apparatus 1 may further include a correction unit 60 that performs correction processing. In this case, the first positioning unit 10 may perform the first positioning processing intermittently at a first location and a second location during movement of the positioning apparatus 1 from the first location to the second location. Also, the second positioning unit 30 may perform the second positioning processing so as to acquire a series of position data regarding the movement from the first location to the second location. Also, in the correction processing, in order for a movement trajectory corresponding to the series of position data to have a similar shape before and after the correction processing, the correction unit 60 may correct the series of position data by uniformly rotating and scaling the position data such that one end of the movement trajectory matches a location corresponding to the first location obtained as a result of positioning performed by the first positioning unit 10, and the other end of the movement trajectory matches a location corresponding to the second location obtained as a result of positioning performed by the first positioning unit 10. With this configuration, the movement trajectory obtained in the second positioning processing can be corrected so as to be closer to the actual moving path.

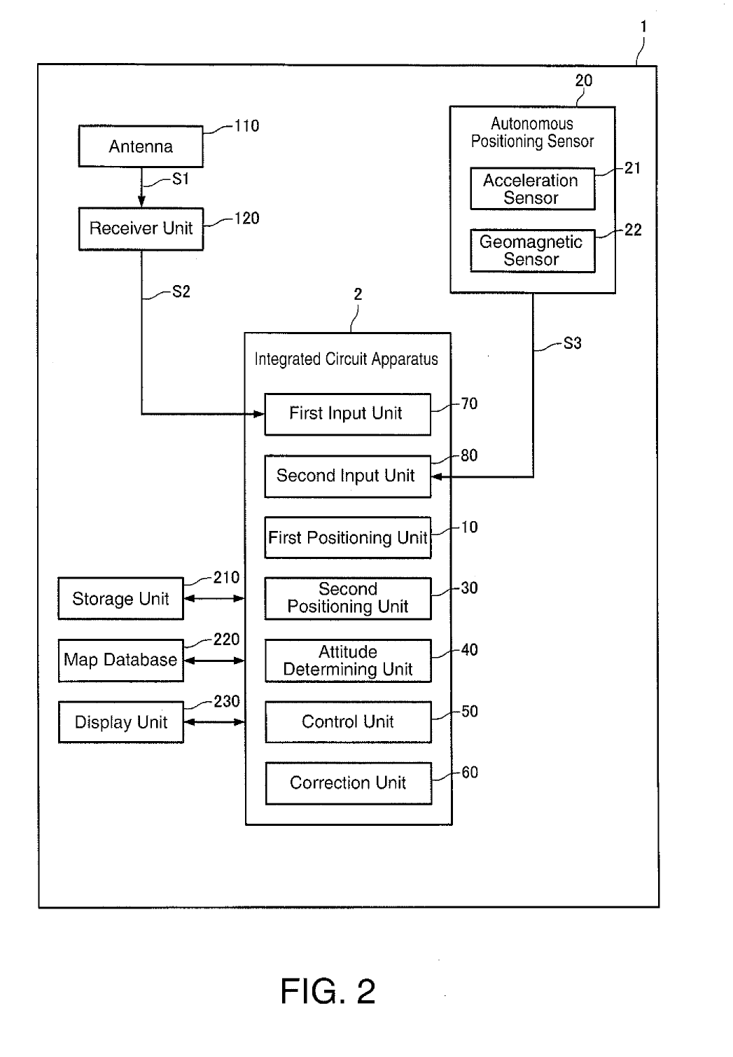

FIG. 2 is a block diagram showing a specific example of a configuration of the positioning apparatus 1 of the present embodiment. The same reference numerals are given to constituent elements that are the same as those shown in FIG. 1, and a detailed description thereof is omitted.

The positioning apparatus 1 shown in FIG. 2 includes an integrated circuit apparatus 2, an autonomous positioning sensor 20, an antenna 110, a receiving unit 120, a storage unit 210, a map database 220 and a display unit 230.

The integrated circuit apparatus 2 includes a first input unit 70 that receives input of location-related information that is information regarding positions based on the radio signal, a first positioning unit 10 that performs first positioning processing that is performed based on the location-related information, a second input unit 80 that receives input of detection result information that is information regarding results of detection performed by the autonomous positioning sensor 20, a second positioning unit 30 that performs second positioning processing that is performed based on the detection result information, an attitude determining unit 40 that determines whether or not the attitude of the autonomous positioning sensor 20 has been changed based on the detection result information, and a control unit 50 that controls the first positioning unit 10. The control unit 50 performs control so as to cause the first positioning unit 10 to perform first positioning processing if the attitude determining unit 40 determines that the attitude of the autonomous positioning sensor 20 has been changed. The integrated circuit apparatus 2 may include a correction unit 60 that performs correction processing.

The first positioning unit 10, the second positioning unit 30, the attitude determining unit 40, the control unit 50, the correction unit 60, the first input unit 70 and the second input unit 80 included in the integrated circuit apparatus 2 may be implemented by dedicated circuits or may be implemented by, for example, a CPU (Central Processing Unit) executing a program stored in the storage unit 210 or the like to cause a computer to function as these units.

Specifically, the functions of the integrated circuit apparatus 2 may be implemented by a program that causes a computer to function as: the first input unit 70 that receives input of location-related information that is information regarding positions based on a radio signal; the first positioning unit 10 that performs first positioning processing that is performed based on the location-related information; the second input unit 80 that receives input of detection result information that is information regarding results of detection performed by the autonomous positioning sensor 20; the second positioning unit 30 that performs second positioning processing that is performed based on the detection result information; the attitude determining unit 40 that determines whether or not the attitude of the autonomous positioning sensor 20 has been changed based on the detection result information; and the control unit 50 that controls the first positioning unit 10, wherein the control unit 50 performs control so as to cause the first positioning unit 10 to perform the first positioning processing if the attitude determining unit 40 determines that the attitude of the autonomous positioning sensor 20 has been changed. Also, the functions of the integrated circuit apparatus 2 may be implemented by an information storage medium in which the above-described program is stored.

The antenna 110 receives a radio signal. In the present embodiment, a radio signal (GPS signal) from the GPS satellite is received. The antenna 110 outputs the received data to the receiving unit 120 as a signal S1.

The receiving unit 120 performs various types of conversion processing based on the signal S1, and outputs location-related information that is information regarding positions to the first input unit 70 as a signal S2. In the present embodiment, the receiving unit 120 performs processing to demodulate the GPS signal received by the antenna 110.

The autonomous positioning sensor 20 outputs detection result information that is information regarding detection results to the second input unit 80 as a signal S3.

The first input unit 70 receives input of the location-related information, and outputs the received location-related information to the first positioning unit 10. The second input unit 80 receives the detection result information, and outputs the received detection result information to the second positioning unit 30.

The storage unit 210 may store therein a program for implementing the functions of the integrated circuit apparatus 2. The program in the storage unit 210 may be stored in advance, or may be stored via an information storage medium, a communication line or the like. The storage unit 210 may also store therein positioning data obtained in the first positioning processing and the second positioning processing. The storage unit 210 may be of any configuration according to the purpose thereof such as, for example, a ROM (Read Only Memory), a RAM (Random Access Memory) or a non-volatile memory. The integrated circuit apparatus 2 may include the storage unit 210.

In the map database 220, map image data of each location is registered. A plurality of map image data sets of different reduction rates may be registered in the map database 220.

The display unit 230 displays various types of information and images. The display unit 230 may display, for example, an image in which a movement trajectory obtained through the first positioning processing and the second positioning processing is superimposed on the map image data registered in the map database 220. The display unit 230 may be of any configuration according to the purpose thereof such as, for example, a liquid crystal display or an electrophoretic display.

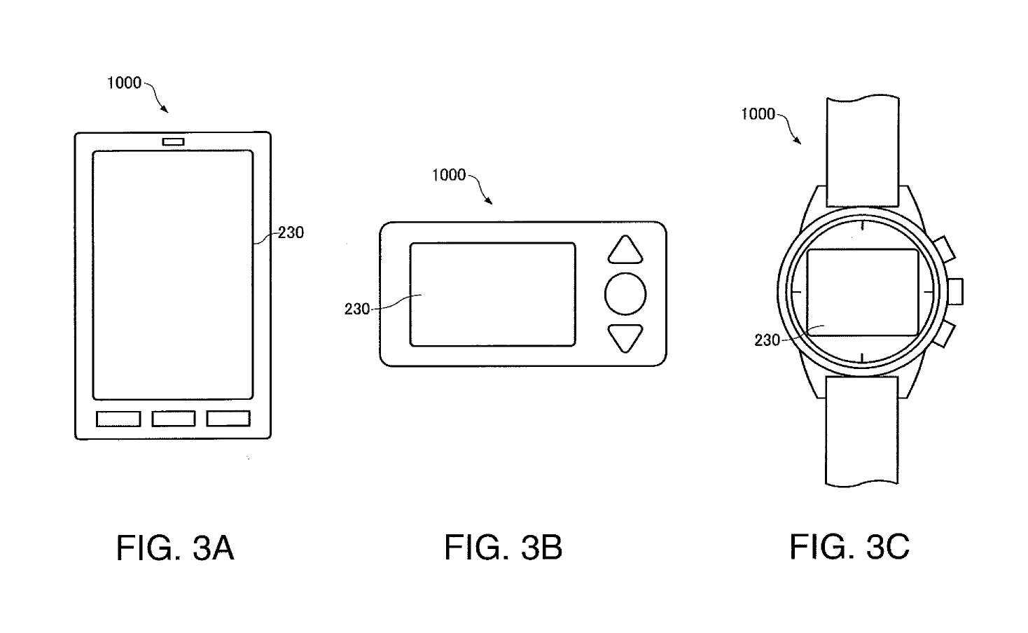

FIGS. 3A, 33 and 3C are diagrams showing examples of the external views of an electronic device 1000.

The electronic device 1000 includes the positioning apparatus 1 or the integrated circuit apparatus 2. The electronic device 1000 may be, for example, a terminal such a smart phone or a mobile phone as shown in FIG. 3A. Alternatively, the electronic device 1000 may be an electronic device of a type that can be put in, for example, a pocket of clothes, or can be fixed to the body or clothes of the user with a band or a clip as shown in FIG. 3B. Alternatively, the electronic device 1000 may be a watch-type electronic device as shown in FIG. 3C. The electronic device 1000 may be a navigation terminal.

2. Example of Operations

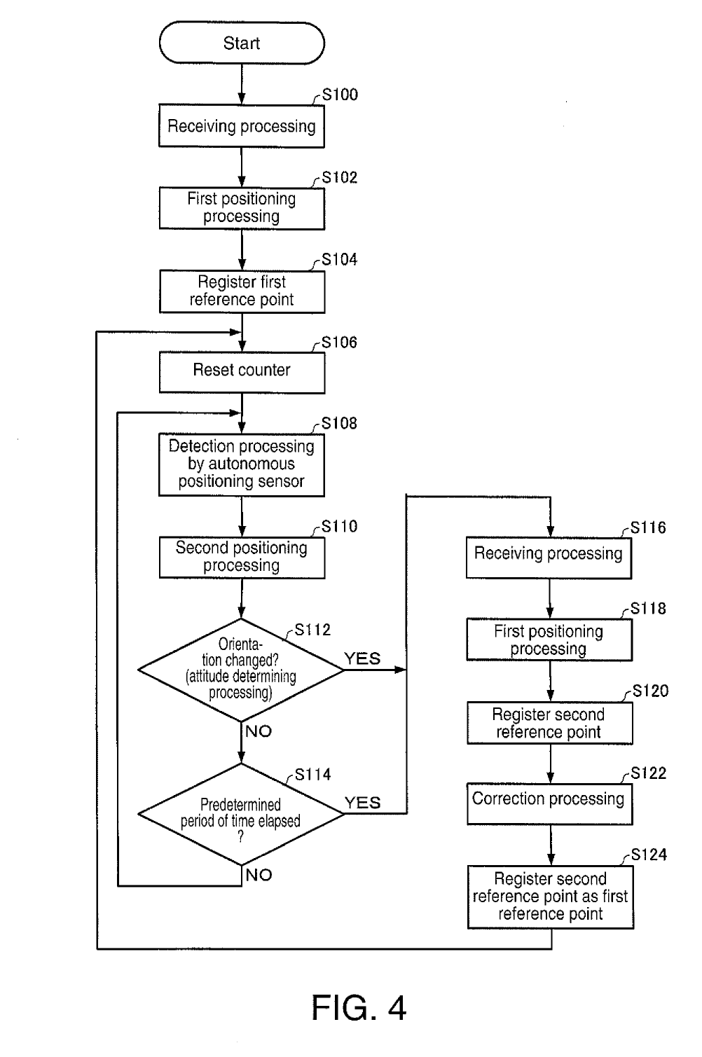

FIG. 4 is a flowchart illustrating an example of operations of the positioning apparatus 1 according to the present embodiment. The following will be described taking as an example, a case where during movement of the positioning apparatus 1 from a first location to a second location, the first positioning unit 10 performs first positioning processing intermittently at the first location and the second location, and the second positioning unit 30 performs second positioning processing, thereby acquiring a series of position data regarding the movement from the first location to the second location.

The positioning apparatus 1 first performs receiving processing (step S100). In the present embodiment, the receiving unit 120 demodulates a GPS signal received via the antenna 110, and outputs location-related information to the first input unit 70 as a signal S2.

Next, the positioning apparatus 1 performs first positioning processing (step S102). In the present embodiment, the first positioning unit 10 performs the first positioning processing based on the signal S2 received by the first input unit 70.

Next, the positioning apparatus 1 registers a first reference point (step S104). In the present embodiment, the first positioning unit 10 stores position information obtained in the first positioning processing in the storage unit 210 as a first reference point. The first reference point may be position information of a location obtained by map-matching the position information obtained in the first positioning processing to a nearby road by referring to the map data stored in the map database 220. The first reference point serves as the start point of positioning in the second positioning processing and a reference point of correction processing.

Next, the positioning apparatus 1 resets a counter (step S106). Tn the present embodiment, the counter (timer) (not shown) for timing a time during which the second positioning processing is performed is included in the integrated circuit apparatus 2, and the integrated circuit apparatus 2 resets the counter.

Next, the positioning apparatus 1 performs detection processing with the autonomous positioning sensor 20 (step S108). In the present embodiment, the acceleration sensor 21 and the geomagnetic sensor 22 included in the autonomous positioning sensor 20 perform the detection processing, and the autonomous positioning sensor 20 outputs detection result information to the second input unit 80 as a signal S3.

Next, the positioning apparatus 1 performs second positioning processing (step S110). Tn the present embodiment, the second positioning unit 30 performs the second positioning processing based on the signal S3 received by the second input unit 80. Also, in the present embodiment, the second positioning unit 30 adds, to the position data acquired in the second positioning processing, an index number indicating the order in which the position data was acquired, a correction flag indicating that the position data has not been subjected to correction processing, and the like, and stores the position data in the storage unit 210.

Next, the positioning apparatus 1 performs attitude determining processing for determining whether or not the attitude of the positioning apparatus 1 has been changed (step S112). In the present embodiment, the attitude determining unit 40 performs the attitude determining processing based on the signal S3 received by the second input unit 80. Also, in the present embodiment, it is determined that the attitude of the positioning apparatus 1 has been changed if the axis where the gravity direction vector is dominant changes.

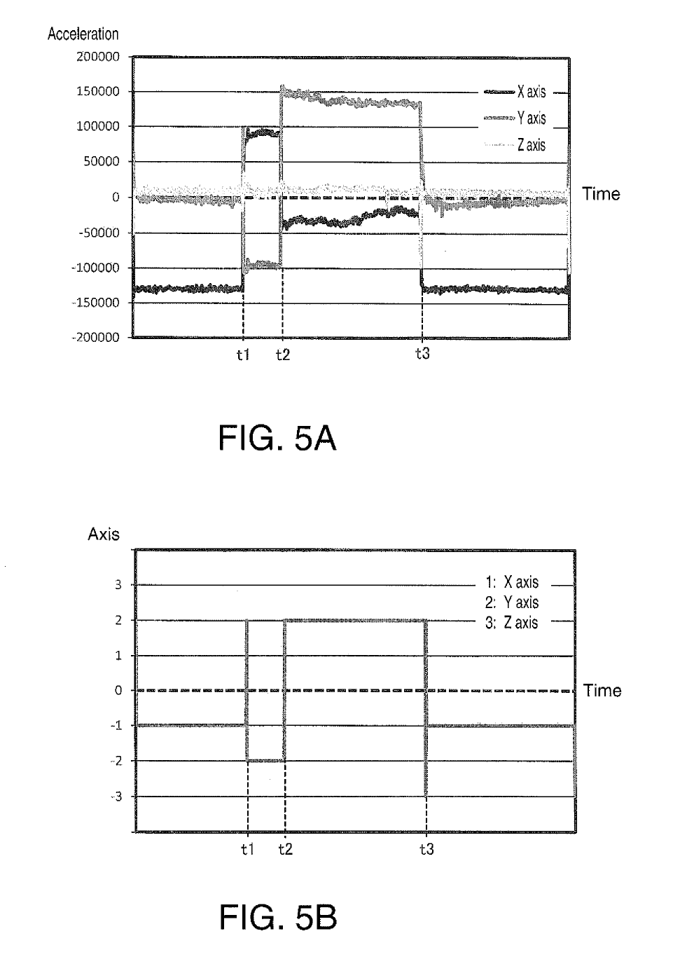

FIG. 5A is a graph showing an example of a result of detection by the triaxial acceleration sensor 21, and FIG. 5B is a graph showing an example of a result of detection of the axis where the gravity direction vector is dominant. In FIG. 5A, the horizontal axis represents time, and the vertical axis represents the magnitude of normalized acceleration in each axis of the acceleration sensor 21. In FIG. 5B, the horizontal axis represents time, and the vertical axis represents the axis where the gravity direction vector is dominant. In the vertical axis of FIG. 5B, value 1, value 2 and value 3 respectively indicate that the plus direction of the X, Y and Z axes is the dominant gravity direction vector. Likewise, value −1, value −2 and value −3 respectively indicate that the minus direction (the direction opposite to the plus direction) of the X, Y and Z axes is the dominant gravity direction vector.

In the example shown in FIGS. 5A and 5B, at time t1, the axis where the gravity direction vector is dominant changes from the minus direction of the X axis to the minus direction of the Y axis. At time t2, the axis where the gravity direction vector is dominant changes from the minus direction of the Y axis to the plus direction of the Y axis. At time t3, the axis where the gravity direction vector is dominant changes from the plus direction of the Y axis to the minus direction of the X axis. Accordingly, in the example shown in FIGS. 5A and 5B, the attitude determining unit 40 determines that the attitude of the autonomous positioning sensor 20 was changed at time t1, time t2 and time t3.

Returning to FIG. 4, if it is determined in step S112 that there has been no change in the attitude of the autonomous positioning sensor 20 (NO in step S112), it is determined whether or not a predetermined period of time has elapsed (step S114) since the counter has been reset in step S106. In the present embodiment, the integrated circuit apparatus 2 determines whether or not a predetermined period of time has elapsed by referring to the counter (not shown). The predetermined period of time may be set to, for example, 5 minutes.

If it is determined in step S114 that a predetermined period of time has not elapsed (NO in step S114), the processing from step S108 to step S114 is repeated.

If it is determined in step S112 that the attitude of the autonomous positioning sensor 20 has been changed (YES in step S112), or if it is determined in step S114 that a predetermined period of time has elapsed (YES in step S114), the positioning apparatus 1 performs receiving processing (step S116). The receiving processing is performed in the same manner as in step S100.

Next, the positioning apparatus 1 performs first positioning processing (step S118). The first positioning processing is performed in the same manner as in step S102.

Next, the positioning apparatus 1 registers a second reference point (step S120). In the present embodiment, the first positioning unit 10 stores, in the storage unit 210, the position information obtained in the first positioning processing as a second reference point. The second reference point may be position information of a location obtained by map-matching the position information obtained in the first positioning processing to a nearby road by referring to the map data stored in the map database 220. The second reference point serves as a reference point of correction processing, which will be described later.

Next, the positioning apparatus 1 performs correction processing (step S122). In the present embodiment, the correction unit 60 performs the correction processing. Also, in the present embodiment, the correction unit 60 adds, to the position data that has been subjected to correction processing, a correction flag indicating that the position data has been corrected in the correction processing, and stores the position data in the storage unit 210. In this case, the position data before the correction processing may be overwritten with the position data after the correction processing, and stored in the storage unit 210.

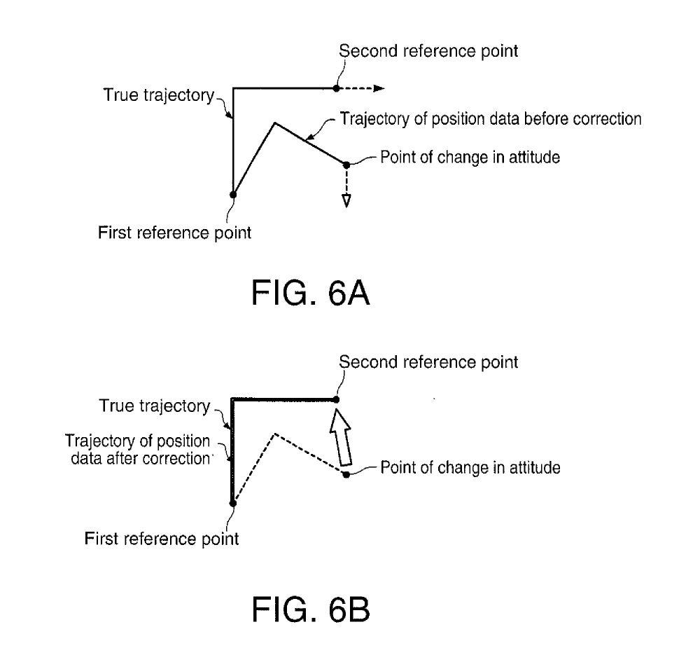

FIGS. 6A and 6B are diagrams illustrating correction processing. FIG. 6A shows a state before correction processing, and FIG. 6B shows a state after correction processing.

In the example shown in FIG. 6A, the trajectory of the position data obtained by the second positioning processing performed after the first reference point has been obtained in the first positioning processing includes errors in the moving direction and the amount of movement with respect to the true trajectory.

When the attitude of the positioning apparatus 1 is changed, the moving direction based on the position data obtained by the second positioning processing may be changed to a direction as indicated by the dotted white arrow from the attitude changing point despite the fact that in the true trajectory shown in FIG. 6A, the moving direction is not changed as indicated by the dotted black arrow. Accordingly, in the present embodiment, when the attitude of the positioning apparatus 1 is changed, first positioning processing is performed to obtain a second reference point.

In the correction processing, as shown in FIG. 6B, in order for a movement trajectory corresponding to a series of position data obtained in the second positioning processing to have a similar shape before and after the correction processing, the series of position data obtained in the second positioning processing is corrected by uniformly rotating and scaling the position data such that one end of the movement trajectory matches a location corresponding to the first reference point obtained as a result of positioning performed in the first positioning processing, and the other end of the movement trajectory matches a location corresponding to the second reference point obtained as a result of positioning performed in the first positioning processing.

Even when there are errors in the moving direction and the amount of movement of the movement trajectory corresponding to a series of position data obtained in the second positioning processing with respect to the true trajectory, the errors can be effectively removed by performing correction processing in the manner descried above.

A conventional technique will be briefly described in order to further demonstrate the superiority of the positioning apparatus 1 of the present embodiment with respect to the conventional technique.

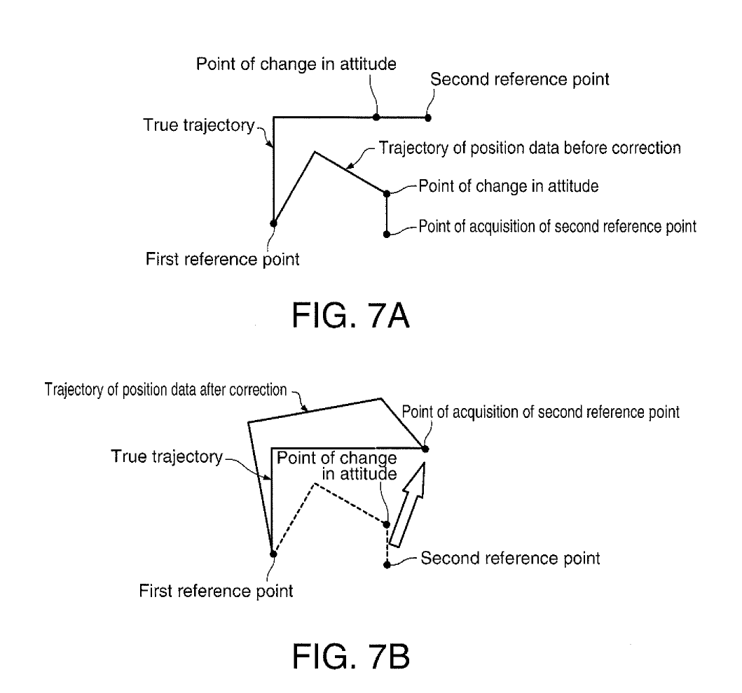

FIGS. 7A and 7B are diagrams illustrating correction processing according to a conventional technique. FIG. 7A shows a state before correction processing, and FIG. 7B shows a state after correction processing.

In the conventional technique, when the attitude of the positioning apparatus 1 is changed, as shown in FIG. 7A, the moving direction based on the position data obtained by the second positioning processing is changed from the attitude changing point despite the fact that the moving direction is not changed at the attitude changing point of the true trajectory. In this case, if the first positioning processing is performed at a timing unrelated to the change in the attitude of the positioning apparatus 1, and a second reference point is acquired, the true trajectory and the movement trajectory corresponding to a series of position data obtained in the second positioning processing do not have a similar shape. As a result, as shown in FIG. 7B, a sufficient effect cannot be obtained even when correction processing is performed.

As described above, with the positioning apparatus 1 of the present embodiment, the movement trajectory obtained in second positioning processing can be corrected so as to be closer to the actual moving path than in the conventional technique.

Returning to FIG. 4, after step S122, the positioning apparatus 1 registers the second reference point registered in step S120 as a first reference point (step S124). In the present embodiment, the correction unit 60 stores the position information stored as the second reference point in the storage unit 210 as a first reference point.

Next, the positioning apparatus 1 returns the procedure to step S106, and repeats the above-described processing.

Although an embodiment or variation of the invention has been described above, the invention is not limited to the embodiment or variation, and can be embodied in various other forms without departing from the spirit and scope of the invention.

For example, the autonomous positioning sensor 20 shown in FIG. 1 or 2 may be provided as an apparatus separate from the positioning apparatus 1, and may be configured to wirelessly receive the signal S3 shown in FIG. 2. The correction unit 60 shown in FIG. 1 or 2 may be configured as an apparatus separate from the positioning apparatus 1. For example, the functions of the correction unit 60 may be implemented by a program executed by a client server system.

The invention encompasses configurations that are substantially the same as those described in the embodiments given above (for example, configurations having the same functions, methods and results, or configurations having the same objects and advantageous effects). The invention also encompasses configurations obtained by replacing a part that is not essential to the configurations described in the embodiments given above by another part. The invention also encompasses configurations that can achieve the same advantageous effects or the same objects as those described in the embodiments given above. The invention also encompasses configurations obtained by adding a known technique to the configurations described in the embodiments given above.

What is claimed is:

1. A positioning apparatus comprising:
a first positioning unit that performs first positioning processing that is performed based on a radio signal;
an autonomous positioning sensor that detects a state of the positioning apparatus;
a second positioning unit that performs second positioning processing that is performed based on an output of the autonomous positioning sensor;
an attitude determining unit that determines whether or not an attitude of the positioning apparatus has been changed based on the output of the autonomous positioning sensor; and
a control unit that controls the first positioning unit,
the control unit performing control so as to cause the first positioning unit to perform the first positioning processing if the attitude determining unit determines that the attitude of the positioning apparatus has been changed.

2. The positioning apparatus according to claim 1,
wherein the autonomous positioning sensor includes an acceleration sensor, and
the attitude determining unit determines whether or not the attitude of the positioning apparatus has been changed based on changes in gravity direction vector detected by the acceleration sensor.

3. The positioning apparatus according to claim 2,
wherein the attitude determining unit determines whether or not the attitude of the positioning apparatus has been changed based on a result of low-pass filter processing of the changes in gravity direction vector.

4. The positioning apparatus according to claim 2,
wherein the autonomous positioning sensor further includes a geomagnetic sensor, and
the attitude determining unit further determines whether or not the attitude of the positioning apparatus has been changed based on changes in yaw angle per unit time detected by the acceleration sensor and the geomagnetic sensor.

5. The positioning apparatus according to claim 1, further comprising a correction unit that performs correction processing,
wherein the first positioning unit performs, during movement from a first location to a second location, the first positioning processing intermittently at the first location and the second location,
the second positioning unit performs the second positioning processing so as to acquire a series of position data regarding movement from the first location to the second location, and
in order for a movement trajectory corresponding to the series of position data to have a similar shape before and after the correction processing, in the correction processing, the correction unit corrects the series of position data by uniformly rotating and scaling the series of position data such that one end of the movement trajectory matches a location corresponding to the first location obtained as a result of positioning performed by the first positioning unit, and the other end of the movement trajectory matches a location corresponding to the second location obtained as a result of positioning performed by the first positioning unit.

6. An integrated circuit apparatus comprising:
a first input unit that receives input of location-related information that is information regarding positions based on a radio signal;
a first positioning unit that performs first positioning processing that is performed based on the location-related information;
a second input unit that receives input of detection result information that is information regarding a result of detection performed by an autonomous positioning sensor;
a second positioning unit that performs second positioning processing that is performed based on the detection result information;
an attitude determining unit that determines whether or not an attitude of the autonomous positioning sensor has been changed based on the detection result information; and
a control unit that controls the first positioning unit,
the control unit performing control so as to cause the first positioning unit to perform the first positioning processing if the attitude determining unit determines that the attitude of the autonomous positioning sensor has been changed.

7. An electronic device comprising the positioning apparatus according to claim 1.

8. An electronic device comprising the positioning apparatus according to claim 2.

9. An electronic device comprising the positioning apparatus according to claim 3.

10. An electronic device comprising the positioning apparatus according to claim 4.

11. An electronic device comprising the positioning apparatus according to claim 5.

12. An electronic device comprising the integrated circuit apparatus according to claim 6.

13. A program that causes a computer to function as:
a first input unit that receives input of location-related information that is information regarding positions based on a radio signal;
a first positioning unit that performs first positioning processing that is performed based on the location-related information;
a second input unit that receives input of detection result information that is information regarding a result of detection performed by an autonomous positioning sensor;
a second positioning unit that performs second positioning processing that is performed based on the detection result information;
an attitude determining unit that determines whether or not an attitude of the autonomous positioning sensor has been changed based on the detection result information; and
a control unit that controls the first positioning unit,
the control unit performing control so as to cause the first positioning unit to perform the first positioning processing if the attitude determining unit determines that the attitude of the autonomous positioning sensor has been changed.
